(19) United States
(12) Patent Application Publication
(10) Pub. No.: US 2026/0099853 A1
(43) Pub. Date: Apr. 9, 2026

(54) CUSTOMER TICKET ROUTING SYSTEM AND METHOD USING INTEGRATED PROGRAMMATIC AND SPECIALIZED GUIDED AND CONSTRAINED ARTIFICIAL INTELLIGENCE

(71) Applicant: Trilogy Enterprises, Inc., Austin, TX (US)

(72) Inventors: Arthur Michel, Brooklyn, NY (US); Colin Guilfoyle, Drogheda (IE)

(73) Assignee: Trilogy Enterprises, Inc., Austin, TX (US)

(21) Appl. No.: 19/352,436

(22) Filed: Oct. 7, 2025

Related U.S. Application Data
(60) Provisional application No. 63/704,539, filed on Oct. 7, 2024.
(60) Provisional application No. 63/711,690, filed on Oct. 24, 2024.

(51) Int. Cl. G06Q 30/015; G06F 16/334; G06F 40/205; G06Q 10/0631; G06Q 10/0633

(52) U.S. Cl. CPC G06Q 30/015; G06F 16/334; G06F 40/205; G06Q 10/06316; G06Q 10/0633

(57) ABSTRACT

An AI-based customer ticket routing system and method for optimizing the efficiency of the AI engine to enhance the ability of the customer routing system to route the customer ticket to a relevant department or agent. The method involves the receiving of customer tickets from the ticket generation platform. The ticket routing system receives the customer ticket and accesses the SRT database. The ticket routing system utilizes an AI engine to check the intent of the customer's tickets. The AI engine guides the ticket routing system to route the customer ticket to a relevant department for resolution which in this case in an agent, automation, L1 bot, and L2 bot.

### CROSS-REFERENCE TO RELATED APPLICATION(S)

This application claims the benefit under 35 U.S.C. § 119(e) and 37 C.F.R. § 1.78 of U.S. Provisional Application Nos. 63/704,539 and 63/711,690, which are incorporated by reference in their entireties.

### FIELD OF THE INVENTION

The present invention relates in general to the field of electronics, and more specifically to an AI-based customer ticket routing system to provide an automated solution on the raised ticket or send it to an agent for resolution.

### BACKGROUND OF THE INVENTION

The ticketing tools automatically assign customer support requests to the most appropriate department or agent to resolve the issue. The ticketing tools ensure the customer's concerns are handled efficiently and accurately. The ticketing tools help to improve customer service and satisfaction. Traditional ticketing tools typically use a fixed set of rules that determine where the tickets should be routed based on specific keywords or categories predefined by administrators. Although rule-based ticketing tools are easy to implement, the tools may not handle the queries effectively that require understanding of context thus leading to misrouted tickets or delays if the rules are not comprehensive or updated regularly. While the rule-based ticketing tools have a predefined set of rules that gives a foundation for the tickets, the tools are less flexible in handling the exceptions and are difficult to manage as the complexity of the rules increases.

Traditional ticketing tools utilize a keywords-matching approach to analyze a ticket's content for certain keywords, assign a priority level to the ticket based on its content, and route the tickets to the most appropriate teams or agents. While the keyword-based approach assigns the tickets quickly to the agent and reduces the costs by minimizing the need for large support teams, these tools often route keyword-specific tickets without understanding the context or complexity of the issues described leading to misrouted tickets and inefficiencies. The traditional ticketing tools provide centralized communication and act as a central location for customer communication and data however, the tools don't adapt or learn from new queries or data thus limiting their ability to improve over time, which leads to inefficiencies in ticket routing.

Conventionally, some companies utilize ticket routing services by hiring a third party to handle the ticketing needs. The services usually rely on human expertise to manage and route the tickets. While the ticket routing services reduce the workload of customer teams by ensuring that tickets are evenly distributed and no team member is overloaded with work, the availing of human expertise to manage and route tickets is more expensive than automated systems. Though the tickets are routed manually by staff members who read and assign the tickets based on their judgments providing the empathy of human intervention, it is highly susceptible to human error and thus leads to inefficiency.

Traditionally, the ticketing tools utilize automation techniques to interpret and route tickets. While the automation techniques in ticket routing enhance accuracy and efficiency, the automation techniques are often not optimized for continuous learning and adaptation leading to stagnancy in performance.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary customer support ticketing system to route customer tickets to the relevant department or agent.

FIG. 2 depicts an exemplary customer support ticketing process to route customer tickets to the relevant department or agent by the customer routing environment.

FIG. 3 depicts an ATLAS ticket utilized by a ticket generation platform which in this case is Zendesk to route the customer ticket to the relevant agent or department.

FIG. 4 depicts a customer ticket resolving process showing the steps to resolve the customer ticket using the customer support ticketing system which is an embodiment of the customer support ticketing process of FIG. 2.

FIG. 5 depicts a data structure for the structured routing document (SRT) to route the ticket to the relevant department or agent.

FIG. 6-9 depicts exemplary user interfaces to implement the product in the ATLAS ticket utilizing the SRT database to route the ticket to a relevant department.

FIG. 10 depicts an exemplary network environment in which the system of FIG. 1 and the process of FIG. 2 may be practiced.

FIG. 11 depicts an exemplary computer system.

### DETAILED DESCRIPTION

A customer support ticketing system and method to use a structured routing document (SRT) tailored to machine learning to enhance the accuracy of the ticket routing to a relevant department or agent. An SRT database includes the SRT document that is specifically optimized for AI processing. The customer support ticketing system incorporates a ticket generation platform that is operatively coupled to a ticket routing system. A customer raises a ticket for a product or service on the ticket generation platform. The customer ticket includes the issues faced by the customer for that product or service. The ticket routing system receives the customer's ticket. The ticket parsing module integrated within the ticket routing system parses the contents of the ticket to extract relevant information from the customer ticket. The SRT matching module integrated within the ticket routing system receives the parsed content from the ticket and accesses the SRT database. The SRT matching module matches the extracted details from the customer ticket to the predefined customer ticket details in the SRT database. The predefined information includes the details of the tickets that the customer has raised in the past.

The SRT database includes the SRT document which is accessed by the ticket routing system to route the tickets to a specific department or agent. The SRT matching module matches the contents of the ticket to different categories in the SRT document. The ticket routing module incorporated within the ticket routing system receives the matched customer ticket to initiate the routing process. The routing module detects and accesses the data from the SRT matching module and populates the prompt structure. The prompt generator generates prompt to guide the AI engine to check if the special instructions and outage-related issues apply to the matched customer ticket. The AI engine guides the routing module if special instructions and outage-related issues apply or not. If the AI engine responds that special instructions and the ticket has outage-related issues apply to the customer ticket, the AI engine responds to the routing module. The routing module deflects the customer ticket, responds to the customer, and updates the customer ticket in the ticket generation platform. If the AI engine responds that for the received customer ticket there are no special instructions and outage-related issues, the routing module populates the prompt structure. The prompt generator generates prompt to guide the AI engine to determine if the customer's ticket has enough information to be processed by the routing module. If the AI engine determines that the customer ticket does not include enough information, the AI engine guides the routing module to route the ticket to an agent, and exits the automation workflow. The routing module updates the status of the ticket in the ticket generation platform and adds one or more tags to the tickets. The tags are given so that the ticket can be easily accessed by the ticket routing system to respond to the ticket in the future.

If the AI engine determines the customer ticket has enough information, the AI engine guides the routing module to route the customer ticket to automation workflow. The automation workflow includes routing the ticket to a relevant department which in this case is automation, L1 module, and L2 module to provide a relevant response to the customer for the customer ticket on the ticket generation platform using the ticket routing system. Based on the response given by the team, tags are provided to the customer ticket, and closes the ticket. If either of the teams within the automation workflow is not able to respond to solve the customer ticket, the customer ticket is automatically passed to the agent.

The structured routing document (SRT) within the customer support ticketing system optimizes the performance of the AI engine such that the customer support ticketing system can more accurately interpret and route tickets based on a deeper understanding of the content and context for each customer ticket. The unique structured routing document (SRT) in the customer support ticketing system enhances overall customer satisfaction and operational efficiency by ensuring that the issues are addressed by the most appropriate and capable team right from the outset. The AI-enhanced approach allows for deeper dynamic learning where the ticket routing system continuously improves the routing accuracy based on new data and interactions. The dynamic learning approach helps the ticket routing system adapt to new types of customer requests and changes in team structures and responsibilities.

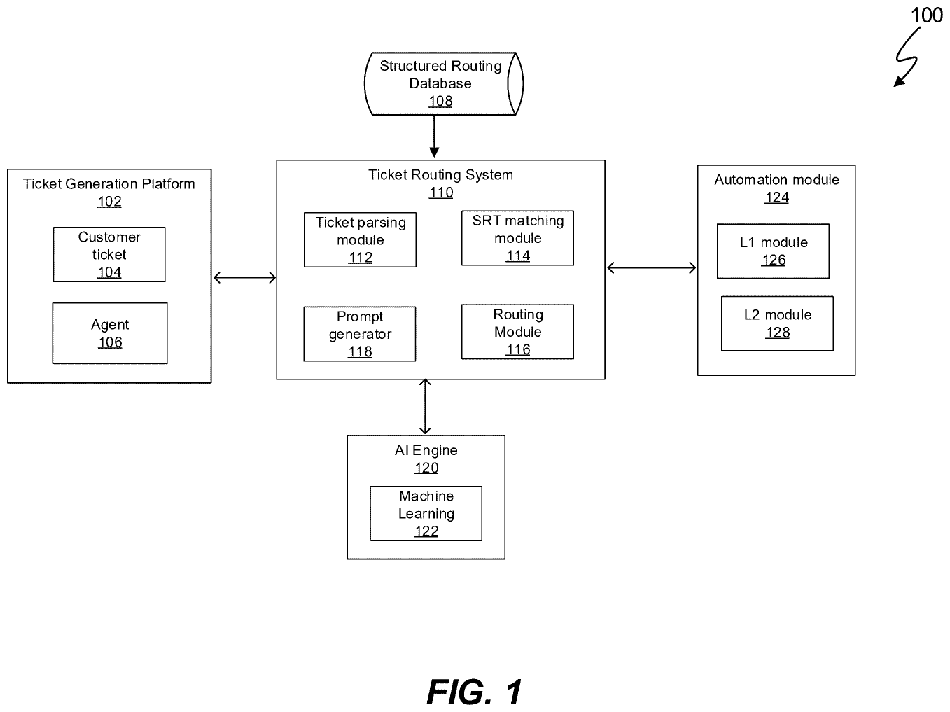

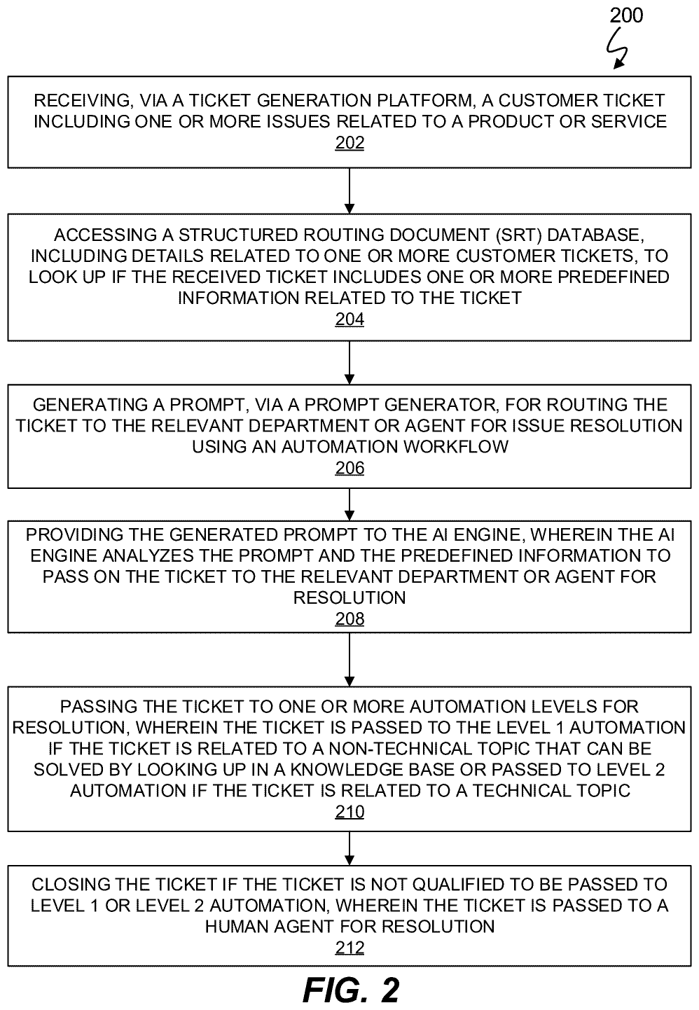

FIG. 1 depicts an exemplary customer support ticketing system 100 to route customer tickets to the relevant department or agent. FIG. 2 depicts an exemplary customer support ticketing process 200 to route customer tickets to the relevant department or agent by the customer routing environment.

Referring to FIGS. 1 and 2, in operation 202, a ticket routing system 110 receives a customer ticket 104 via a ticket generation platform 102, where the customer ticket 104 includes issues related to a product or service.

The customer raises the ticket to highlight any issues he/she is facing while using one or more products or services linked to the ticket generation platform 110. The ticket generation platform 110 allows the customers to submit a formal request notifying the issue for that product or service. The formal request is in the form of a customer ticket 110, which includes details of the customer and issues such as ticket ID, status, and created date, customer's name, email address, and phone number. In at least one of the embodiments, the customer ticket can also include attachments, notes, or screenshots for the issues faced by the customer.

The ticket generation platform 102 receives customer tickets 104 using various channels. The customer tickets 104 can be received using channels including email, chat, phone, web form, mobile support app, Facebook, other social media messaging channels, support UI, etc. In at least one of the embodiments, omnichannel routing can be used to route the tickets from channels including emails, chat, phone calls, social media, and messaging apps.

The ticket generation platform 102 is one or more customer support platforms including Zendesk or Kayako. Zendesk and Kayako are cloud-based software companies providing different products to help businesses improve customer service and sales. Zendesk is headquartered in San Francisco, California, USA and Kayako is headquartered in London United Kingdom. Zendesk and Kayako are customer service and engagement platforms that help businesses improve customer service by providing solutions to the customer for customer ticket 104 providing issues related to a product or service.

In one example, a customer named Alice sends an email using his email id ‘alice@gmail.com’ to the support email address using omnichannel routing of the ticket generation platform 102 to raise a customer ticket 104 for an issue related to ‘payment’. The support email address of the ticket generation platform 102 will be utilized to send replies to Alice. The ticket generation platform 102 creates the customer ticket 104 for a ‘payment issue’. The customer ticket 104 for payment-related issues includes the following details such as ‘customer name: Alice’, email address: ‘alice@gmail.com’, contact details: ‘+1 408 XXX XXXX’, the detailed description related to the issue: ‘Alice attempted to place an order using his credit card but the payment failed with the message transaction declined’, attached document: ‘screenshot of the error message’.

The ticket routing system 110 operatively coupled to the ticket generation system 102 receives the customer ticket 104 via the ticket generation platform 102. The ticket routing system 110 directs the customer tickets 104 to the right agent 106 or department to resolve the issues related to a product or service quickly and efficiently. An agent 106 is a user or representative who responds to customer tickets 104 which includes inquiries, issues, and support requests to resolve issues related to a product or service. The agents 106 is assigned to resolve the customer ticket 104 based on the required skills to resolve the raised ticket. The ticket routing system 110 is ATLAS which is configured to initiate the automation workflow upon receipt of any new customer ticket.

In operation 204, the ticket routing system 110 accesses a structured routing document (SRT) database 108 including details related to one or more customer tickets to look up if the received customer ticket 104 includes one or more predefined information related to the ticket.

The ticket routing system 110 utilizes a ticket parsing module 112 to parse the received customer ticket 104. The ticket parsing module 112 is integrated into the ticket routing system 110. The ticket parsing module 112 extracts the relevant information from the customer tickets 104. The ticket-parsing module utilizes one or more parsing techniques to extract the required relevant information or details from the customer ticket. In at least one of the embodiments, various techniques for parsing include JSON parsing, Shift reduce parser, Parser generator, String Parsing, etc. For instance, if the customer ticket 104 contains ‘I need a refund for my order having order number #3421, the ticket parsing module utilizes a JSON parsing technique that includes extraction of keywords such as ‘refund’ and ‘order number #3421’ in a JSON format. The ticket parsing module 112 identifies relevant fields including customer ID, name, and description of the issues faced by the customer. The ticket parsing module 112 then organizes the extracted ticket information or details into a structured format. The structured format can be in the form of .JSON, .XLMS, .XML, .CSV, and more.

Moreover, the ticket parsing module 112 assigns priority to customer ticket 104 by parsing the information in customer ticket 104. The ticket priority determines the order in which the tickets are to be handled. The ticket priority ensures that critical tickets are handled and resolved first. The ticket parsing module 112 utilizes a priority assignment algorithm to determine the priority of the ticked based on the keywords and urgency indicators within customer ticket 104. For instance, if a customer ticket 104 includes keywords such as ‘urgent’, or ‘payment failure’ the customer ticket 104 is assigned as high priority ticket that needs to be resolved immediately.

The SRT matching module 114 receives the extracted information of customer ticket 104 from the ticket parsing module 112. The SRT matching module 114 is integrated into the ticket routing system 110. The SRT matching module 114 accesses the SRT database 108. The SRT matching module 114 determines if the extracted information from customer ticket 104 includes one or more predefined information related to the product or service in the SRT database 108. The predefined information includes one or more details included in the SRT, which allows matching of the ticket to the details in the SRT. The SRT matching module 114 utilizes a text matching algorithm to match the contents in the extracted information of customer ticket 104 with the SRT descriptions in the SRT database 108 to identify if customer ticket 104 contains any information within the SRT database 108.

The SRT database 108 includes an SRT document that has machine learning-friendly predefined information related to the product or service. The predefined information provides details related to one or more customer tickets that have been raised in the past for a particular product or service. For each product, the SRT data includes key elements such as ‘categories’, ‘descriptions’, ‘team allocations’, and ‘required information’. Each ticket type is categorized with a short heading providing information on the nature of the issue. The category is accompanied by a description related to the category. The SRT document within the SRT database 108 also contains details about the team routing information, specifying which team will receive the ticket. This targeted routing ensures that tickets are handled by the most appropriate team thereby reducing the response time and improving resolution efficiency. The SRT document also contains details about the required information which outlines what information should be included in the ticket for it to be processed effectively. For instance, the product ‘Central Finance’ details category ‘Accounts payable create a vendor’ and description ‘I need to create a vendor to allow a Purchase Order to be created’. The information indicates that the ticket in the past has been raised for accounts payable to create a vendor and includes the description of the issue in which the customer seeks help in creating a vendor to allow the purchase order to be created and the required information for this request should contain the invoice number or a screenshot, attachment with details.

For instance, the customer raises a ticket via the ticket generation platform 102, where the ticket is related to the ‘payment issues’ such that the customer tried to purchase a subscription and the payment was incomplete. The ticket routing system 110 receives the customer ticket 104. The ticket parsing module 112 within the ticket routing system 110 extracts relevant keywords such as ‘payment’, ‘purchase’, ‘subscription’, and ‘urgent’. The ticket parsing module 110 determines the ticket of high order priority based on the extracted keywords that include ‘urgent’, and ‘payment’. The ticket parsing module 112 transfers the parsed information to the SRT matching module 114. The SRT matching module 114 utilizes the extracted information from customer ticket 104 to see if the extracted information from the customer ticket 104 includes details related to the tickets that have been raised in the past, where details related to past tickets are listed in the te SRT database 108. The SRT database 108 includes multiple categories for payment-related issues including ‘refund’, ‘duplicate charges’, ‘payment declined’, and various others. The SRT matching module 114 matches and finds the most relevant ticket details in the SRT database 108 to that of the customer ticket 104. The SRT matching module 114 matches the extracted keywords such as payment, and purchase to the most relevant category within the SRT database 108 which in this case is payment declined. The matching helps in the identification that customer ticket 104 has details in the SRT database 108. The SRT matching module 114 accesses the details and passes the details to the routing module 116

The routing module 116 receives the matched information for customer ticket 104 from the SRT matching module 114. The routing module 116 is integrated into the ticket routing system 110. The routing module 116 decides the path of routing of the customer ticket 104. The routing module 116 has the matching information of the customer tickets 104. The routing module 116 decides the routing of the tickets to a relevant agent or department to resolve the issues raised in the customer ticket 104. The routing module 116 utilizes the matched information from the SRT matching module 114 to decide the path of the customer tickets 104.

The insights collected from the routing module 116 are then fed into a prompt generator 118. The prompt generator 118 is operatively coupled to the routing module 116. By utilizing the collected and analyzed information, routing module 116 ensures that the module enhances the routing process.

In operation 206, the prompt generator 118 generates a prompt 119 to guide the AI engine 120 to route the ticket 104 to the relevant department or agent for issue resolution using automation workflow.

The routing module 116 populates the prompts structure. The prompt generator 118 generates prompt 119 to guide the AI engine 120 to provide instructions to the routing module 116. The routing module 116 receives information from the AI engine 120 to route the customer ticket 104 to the relevant agent 106 or department. Ticket routing is a process that includes assigning the received customer ticket 104 to an agent 106 or department using automation workflow.

The SRT matching module 114 analyzes if the matched customer ticket 104 contains special instructions and a status page for the product or service for which the customer has raised the ticket. The status page within the SRT database 108 is for power utilities to check if there are any outage-related issues for that product or service. The status pages mainly apply to the software products. For instance, a ‘server down’ issue in a software product can be considered an outage issue. The special instructions are out-of-norm instructions including details related to the product in the SRT database 108. For instance, the special instructions for the software ‘Worksmart’ include information in SRT database 108 of ‘time cards not uploading’

The routing module 116 receives the matched information of customer ticket 104 to route the customer ticket 104 to relevant agent 106 or automation workflow. The ticket routing system 110 assigns the tickets using an automation workflow where the machine learning models are utilized to automatically route the tickets to specific departments or agents 106. The SRT database 108 includes predefined information on the automation workflow which defines the team to whom the matched customer ticket 104 will be assigned. The routing module 116 decides the path of routing to assign customer ticket 104 to where the ticket routing system 110 can use automation to provide a solution for the customer ticket 104 or the customer ticket 104 is sent to L1 module 126, L2 module 128, or agent 106.

The SRT matching module 114 identifies if the matched customer ticket 104 consists of special instructions and a status page for outage-related issues for the product. The routing module 116 receives the matched information of the customer ticket 104 from the SRT matching module 114. The routing module 116 populates the prompt structure.

For each matched ticket two case scenarios are possible for special instructions. For the first case scenario, the routing module 116 receives information about the matched customer ticket 104 wherein the customer ticket 104 raised for a particular product or service has special instructions in the SRT database 108. For instance, a product ‘Crossover’ has special instructions including ‘if a customer reports that time cards are not uploading let them know to use the latest version of ‘Worksmart tracker’. For this case, the routing module 116 populates the prompt structure with the details of the matched customer ticket 104 and special instructions from the SRT database 108 for the prompt generator 118. The prompt generator 118 generates prompts to guide the AI engine to check if the special instructions apply to the matched customer ticket 104. The special instructions apply to describe if the issue described in the matched ticket is related to the information given in the special instructions or not. The prompt structure includes the information of the matched customer ticket 104 which comprises the customer's name, email address, details of the issue in the matched customer ticket, and special instructions for the matched customer ticket 104 from the SRT database 108.

Provided below is an exemplary prompt 119 generated by prompt generator 118 to check if the special instructions apply or not:

### Prompt Explanation

The prompt 119 include the details of the messages which in this case is the information included in the customer ticket 104. The prompt 119 also include special instructions from the SRT database 108 for the relevant product or service for which the customer has raised the ticket. The prompt 119 guide the AI engine 120 to provide information as true if the special instructions apply and false if they don't apply.

For the second case scenario, if routing module 116 identifies that the information in the matched customer ticket 104 does not contain special instructions for a particular product, routing module 116 will route the customer ticket 104 further to be processed to route it to the relevant team.

For each matched ticket, two case scenarios are possible for the status page. For the first case scenario, the routing module 116 receives information about the matched customer ticket 104, wherein the customer ticket 104 for a particular product or service includes a status page in the SRT database 108. For instance, the customer raises a customer ticket 104 mentioning that Jive is not able to send the emails. The SRT database 108 for that product includes a column on the status page. The routing module 116 based on the information populates the prompt structure for the prompt generator 118. The prompt generator 118 generates prompt 119 to guide the AI engine 120 to check if the outage issues apply to the matched customer ticket 104.

Provided below is an exemplary prompt 119 generated by prompt generator 118 to check if the special instructions apply or not:

### Prompt Explanation

The prompt 119 include the details of the messages which in this case is the information of contents in the customer ticket 104. The active incidents include outage-related issues for the relevant product or service the customer ticket 104 is raised.

For the second case scenario, if routing module 116 identifies that the information in the matched customer ticket 104 does not contain outage-related issues for a particular product, routing module 116 will route the customer ticket 104 further to be processed to route it to the relevant team.

The AI engine 120 receives the prompts to check if special instructions apply or not to provide information to routing module 116 to route the customer ticket 104.

In operation 208, the AI engine 120 receives and analyzes the prompts to pass the customer ticket 104 to the relevant department or agent for resolution.

The prompt generator 118 is operatively coupled to the AI engine 120. The prompt generator 118 generates the prompt 119 for the AI engine 120 to check whether the special instructions and outage-related issues apply. The AI engine 120 then responds to the prompt 119 using machine learning 122. The response is then sent back to the routing module 116 of the ticket routing system 110.

The AI engine 120 receives the prompt 119 using an API endpoint. The API endpoint is a location within the API that allows the ticket routing system 110 and AI engine 120 to communicate with each other. The AI engine 120 utilizes machine learning 122 techniques to identify if the special instructions and outage-related issues apply or don't apply to the matched customer ticket 104. The machine learning 122 is integrated into the AI engine 120. The machine learning 122 utilizes Large Language Models (LLM) to understand the information mentioned in the matched customer ticket 104 to check if the information in the customer ticket 104 matches the details mentioned in the special instruction and outage-related issue column of the SRT database 108.

If machine learning 122 module predicts that the information in customer ticket 104 matches the special instructions or outage-related issues. The AI engine 120 responds to routing module 116 as true if either of them applies and false if the special instructions and outage-related issues don't apply. The routing module 116 populates the prompt structure to send a reply back to the customer providing information about outage-related issues or special instructions.

Provided below is an exemplary prompt 119 generated by the prompt generator to generate a message for the customer if the special instructions or outage-related issues apply;

### Prompt Explanation

The prompt generator 118 generates prompt 119 for AI engine 120 to respond to the routing module 116. The routing module 116 updates the response in the ticket generation platform 102.

The AI engine 120 receives the prompt 119 to generate a message for the customer. For instance, the customer raises a ticket for ‘time cards not uploading’. The AI engine 120 will create a public reply (PR) which is defined as the response given to the customer which in this case is the message along with the solution. The solution is received by the routing module 116 of the ticket routing system 110. The ticket routing system 110 will deflect the ticket from the automation workflow and update the ticket in the ticket generation platform 102. The ticket routing system 110 marks the ticket PR pending in the ticket generation platform 102. The customer ticket 104 is marked as a PR pending which provides a solution to the customer on the ticket generation platform 102 that guides the customer to download a new version of the app. The status helps the ticket routing system 110 to address the ticket in the future.

If the AI engine 120 responds to routing module 116 special instructions and outage-related issues do not apply. The routing module 118 will look for entries within the SRT database 108 for the matched ticket. The entries include information on categories with the description. For this, two case scenarios are possible, the first case scenario is when the customer ticket 104 does not include any entries within the SRT database 108. The routing module 118 will route the ticket to agent 106. For instance, educational products do not have entries in the SRT database 108. For this case, the routing module 116 within the ticket routing system 110 routes the customer tickets 104 with issues in the educational product to agent 106 and exits the automation workflow. The agent 106 will resolve the issues related to this ticket.

For the second case scenario, the routing module 116 analyzes if the information in the matched customer ticket 104 includes entries within the SRT database 108. If the matched customer ticket 104 includes entries within the SRT database 108, the routing module 116 will populate the prompt structure to check if there is enough information in the matched customer ticket 104. Enough information within customer ticket 104 includes if the customer has given enough details within the ticket to resolve the ticket.

Provided below is an exemplary prompt 119 generated by the prompt generator 118 to guide the AI engine 120 to identify if the information in matched customer ticket 104 contains enough information for the routing module 116 to route it to a relevant department for resolution:

### Prompt Explanation

The routing module 116 populates the prompt structure for the prompt generator 118 with the required information of the matched customer ticket 104 which has been assigned a specific category and details of the ticket collected from the ticket generation platform 102. The information of the matched customer ticket 104 includes details of the customer which includes the name, and date of issue. The required information includes the details that are required in customer ticket 104 so that the issue can be resolved.

The prompt generator 118 provides prompt 119 to the AI engine 120 to thoroughly analyze if the customer ticket contains enough information. The AI engine 120 will analyze the information in customer ticket 104 which includes the messages that have been exchanged in customer ticket 104. The AI engine 120 utilizes machine learning 122 to match the intents of the customer ticket to that of the description and required information which is present within the SRT database 108. The customer intent is defined as understanding the needs of the customer which is mentioned within the customer ticket 104. The machine learning 122 algorithms analyze if the matched customer ticket belongs to a specific category within the SRT database 108. If the matched customer ticket 104 belongs to a category, the AI engine 120 analyzes if the category to which customer ticket 104 belongs contains the required information for the customer ticket 104 to be processed.

If the AI engine 120 determines that the information is insufficient and does not contain enough information, then the AI engine 120 instructs the routing module 116 to proceed and generate prompt 119 to send a public reply (PR) to the customer and set it to pending. The public reply includes asking the customer to provide more details related to the product. For instance, the machine learning 122 algorithms identify that the product ‘central finances’ includes various categories where the matched customer ticket 104 belongs to the category ‘Account payable invoice query’ by analyzing the intent of the messages exchanged within the customer ticket 104. For the category ‘Account payable invoice query’, the required information is that the customer ticket 104 should include ‘invoice number or screenshot/attachment with details’. The machine learning 122 determines from the information in customer ticket 104, that the customer has not included any details as well as a screenshot for the problem.

The AI engine 120 responds to the routing module 116 to send a public reply (PR) to the customer. The routing module 116 updates the customer ticket 104 within the ticket generation platform 102 and provides tags to the customer ticket 104. The PR includes information for the customer to provide details for the customer ticket 104 he/she has raised on the ticket generation platform. The tags are added on the ticket generation platform 102 to identify the stage at which customer ticket 104 is. The stage of customer ticket 104 makes it easy for the ticket routing system 110 to route the ticket to the relevant team. The routing module 116 updates the tag of the ticket where the tag is ‘customer-ticket-more-info’ indicating that the ticket requires more information for resolution. The information on the tickets is tracked within the ticket generation platform 102 which can be accessed by the ticket routing system 110 to route the customer ticket to the next step in automation workflow. The AI engine 120 generates a list of the missing information for that customer's ticket along with the relevant links to send a PR on the ticket generation platform 102. Moreover, the AI engine 120 guides the ticket routing system 110 to update the details of the missing information in the required information section of the SRT database for future reference if the customer raises the same ticket.

For instance, if the customer did not include the screenshot of the ‘invoice payment’, the AI engine 120 generates a response that is accessed by the routing module 116. The routing module 116 will provide the PR in the ticket generation platform 102 and put the ticket to PR pending which indicates the ticket is yet to be resolved. The response includes providing the attachments and documents to resolve the ticket. The routing module 116 updates the tag of the ticket where the tag is ‘customer-ticket-more-info’ indicating that the ticket requires more information for resolution. The information on the tickets is tracked within the ticket generation platform 102 which can be accessed by the ticket routing system 110 to route the customer ticket to the next step in automation workflow.

If the AI engine 120 determines that the information is adequate and the customer ticket 104 contains enough information, then the AI engine 120 instructs the routing module 116 to proceed and generate prompts for the next steps in the automation workflow. The routing module 116 based on the information provided passes the customer ticket 104 to the relevant department in automation workflow to provide a solution for the customer ticket 104.

For instance, the machine learning 122 algorithms identify that the product ‘Answerhub’ includes various categories where the matched customer ticket 104 belongs to the category ‘errors received’ by analyzing the intent of the messages exchanged within the customer ticket 104. For the category ‘errors received’, the required information is that customer ticket 104 should include a ‘description of the problem. ‘Attachment of HAR file when an error is observed?’, ‘screenshot of the error’? and ‘clarification of the activity that triggered the error?’. The machine learning 122 determines from the information in customer ticket 104, that the customer has included enough information for the routing module 116 to route the ticket to a relevant department.

The customer responds to the PR on the ticket generation platform 102 and provides information for the ticket routing system 110. The routing module 116 routes the customer ticket for automation where firstly the ticket routing system 110 will itself try to resolve the issue. The issues that are resolved by the ticket routing system 110 include simple issues that are raised once or twice a week. The routing module 116 identifies based on the ticket information that the ticket needs to be passed to automation for resolution. The ticket routing system 110 will try to resolve the issue using automation techniques. For instance, a customer raises a customer ticket 104 which starts with ‘DNN store payments’ for’, the routing module 116 runs automation techniques. The automation techniques apply a tag to the ticket. The tags are applied to organize customers into groups using specialized labels. For this request, the ticket routing system 110 applies a tag ‘ai-cfin-treasuryrequest’ on the ticket generation platform 102. As the tag is applied a ticket is raised for the treasury team request with ticket ID of the ticket, description, and name of the requester. The ticket is raised in a JSON format. The information is passed to an endpoint. The endpoint is a specific URL that passes the information to the lambda function which looks upon the details of the raised customer ticket and passes the information to the ticket routing system 110 to look at the contents of the ticket and use automation techniques to resolve the issue and update the ticket as complete. If there is no automation check the routing module 116 passes the ticket to the automation module 124 for resolution.

In operation 210, the routing module passes the tickets to the automation module to identify if the ticket will be passed onto the L1 module 126 or L2 module 128.

The automation module 124 is operatively connected to the ticket routing system 110. The routing module 116 identifies that for the matched customer ticket 104, the automation is not used to provide a solution for the issue, the routing module passes the customer ticket to L2 module 126 and L1 module 128. The routing module 116 determines if, for the matched customer ticket, the ticket is assigned to the L1 team or the L2 team. If the category for that matched customer ticket 104 includes details in the SRT database 108 to be resolved by the L1 team, the routing module 116 passes the customer ticket 104 to the L1 module 126. If the category for that matched customer ticket 104 includes details in the SRT database 108 to be resolved by the L2 team, the routing module 116 passes the customer ticket 104 to the L2 module 128.

The L2 module 128 is integrated into the automation module 124. The L2 module 128 is operatively coupled to the ticket routing system 110. The L2 module 128 is an L2 troubleshooting bot that responds to customer ticket 104 if customer ticket 104 is related to a technical topic. A technical topic is defined as a topic that requires special and practical knowledge to resolve the issue. The L2 troubleshooting bot is an advanced bot. The routing module 116 analyzes if the automation is not enabled in the SRT database 108, the SRT matching module 114 will look for the L2 endpoint for that category of the customer ticket 104. If the L2 endpoint is enabled in the SRT database 108, the routing module 116 routes the customer ticket to L2 module 128 using an API endpoint that provides the information to the L2 module 128.

For the L2 module 128, the ticket routing system 110 provides ticket information via an endpoint which includes the attachments, internal notes, and screenshots for that customer ticket 104. The L2 module 128 provides an answer to the ticket routing system 110 for the customer ticket 104. If the L2 module 128 provides an answer to the ticket routing system 110, the ticket routing system 110 updates the ticket in the ticket generation platform 104. The ticket routing system 110 provides a tag to the ticket L2 attempt. If the L2 module 128 does not provide any answer, the raised customer ticket 104 will be passed to the L1 module 126.

The ticket routing system 110 will provide the ticket ID information using the endpoint which can be accessed by the L2 module 128. The ticket ID will be in the JSON format (as shown below). The JSON format only includes details of the ticket ID.

The L2 module 128 responds to the ticket routing system 110. The response time is about 10 minutes. The response time is defined as the time taken by the L2 module 128 to respond to the ticket routing system 110. The L2 module 128 sends an expected response which is a complete ticket response to send to the customer. The ticket routing system 110 sends a public reply to the customer and sets the ticket to pending if the L2 module 128 requires more information to resolve the ticket The L2 module 128 responds in HTML format:

The L1 module 126 is integrated into the automation module 124. The L1 module 126 is an L1 troubleshooting bot that responds to customer ticket 104 if the customer ticket is related to a nontechnical topic. The L1 troubleshooting bot is defined as a chatbot that helps customers by providing them with solutions to their problems and thus resolving the issue. The L1 module 126 receives the customer ticket if the L2 module 128 does not provide an answer.

The L1 module 126 looks at the voice flow key in the SRT database 108 of the matched customer ticket 104 to get the answers. The L1 module 126 looks for the answers in the knowledge base. The knowledge base is a central repository of information which includes information about the products, and services. The voice flow key is utilized as a lookup for the knowledge base to get the answers. The L1 module 126 is utilized to provide answers to nontechnical problems. For instance, a customer raises a ticket on how to set up an expense system. The L1 module 126 provides an answer by accessing the knowledge base and provides articles on how to set up an expense system. The ticket routing system 110 updates the ticket and provides a tag of ticket-L2 attempt.

In operation 212, the ticket routing system 110 closes customer ticket 104 if the ticket is not qualified for level 1 automation or level 2 automation, and the ticket is passed to a human agent 106 for resolution.

The routing module 116 of the ticket routing system 110 passes the customer ticket 104 to agent 106 when either of the modules within the automation workflow is unable to solve the issue. The ticket routing system 110 exits the ticket from the automation workflow The human agent responds to the ticket updates the ticket in the ticket generation platform 102 and closes the ticket.

The agent 106 is notified of the pending request based on the routing. The agent 106 is assigned based on their availability and ability to provide the right response to the customer. The agent 106 reviews the customer ticket 104 to respond to the customer and sets the ticket to close.

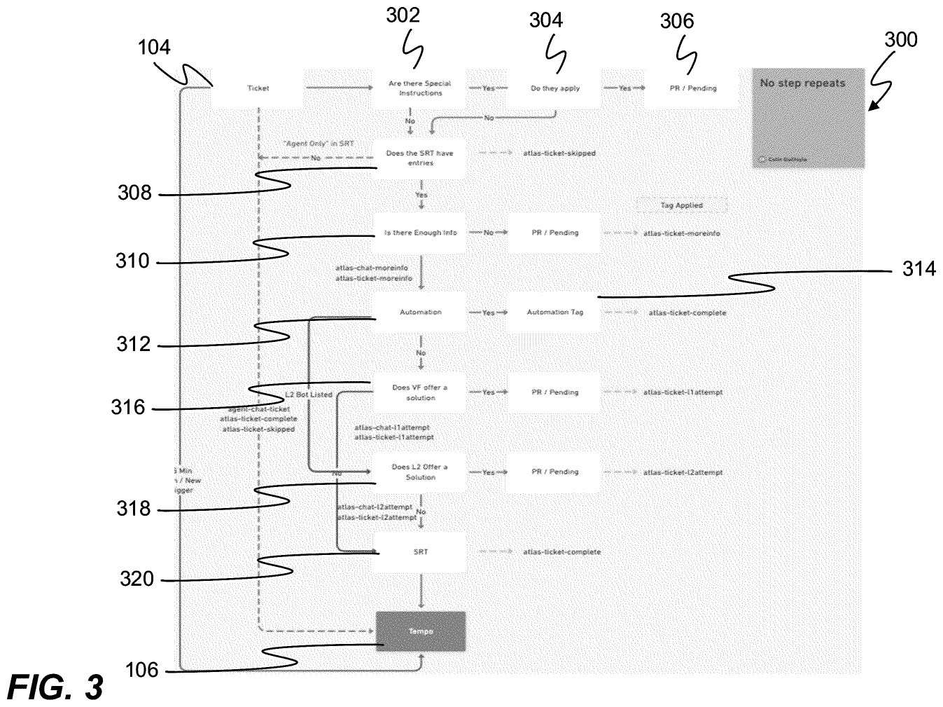

FIG. 3 depicts an ATLAS ticket utilized by a ticket generation platform 102 which in this case is Zendesk to route the customer ticket 102 to relevant agent 106 or department.

The customer raises a customer ticket 104 within Zendesk. The ATLAS ticket utilizes intelligent AI triage to route the tickets to a relevant department or agent 106. The triage is a process for routing the customer tickets 104. The ATLAS ticket receives customer ticket 104. The ATLAS ticket utilizes an SRT document to perform a triage. The SRT document includes the predefined information of the tickets that have been raised in the past. The ATLAS ticket looks if there are any special instructions 304 within the SRT document for which the customer ticket 104 has been raised. The ATLAS determines if there are special instructions for that product for which the customer ticket is raised, the contents of the customer ticket 104 are passed to AI engine 120 to check ‘Do they apply’ 304. The AI engine 120 utilizes GPT to check if the instructions apply. The AI engine 120 checks the intent of the customer ticket. The AI engine 120 guides the ATLAS ticket to act by sending a public reply (PR) 306 to the customer on Zendesk and applying any tags if special instructions and outage-related events apply. If the AI engine 120 responds back that the special instructions and outage-related events do not apply, the AI engine 120 guides the ATLAS ticket to route the customer ticket 104 to the relevant department.

The ATLAS ticket now looks for entries of the relevant product for which customer ticket 104 is raised which includes checking ‘Does the SRT table include entries’ 308. If the SRT table includes the entries the ATLAS ticket routes the customer ticket 104 to the next steps in the automation workflow. If the ATLAS ticket finds that there are no entries for that product in the SRT table, the ATLAS ticket routes customer ticket 104 to agent 106. The ATLAS ticket first checks if there is enough information 310 within the customer ticket 104 so that the ticket can be processed. If there is enough information, the ATLAS ticket passes customer ticket 104 to automation workflow.

The ATLAS ticket first checks if the customer ticket 104 can be resolved via automation 312 that is by the ATLAS ticket itself. The ATLAS ticket with the help of AI assigns tags to the customer ticket 104. The tags are updated in Zendesk. If the ATLAS ticket applies an automation tag 314 within the Zendesk. For instance, if the tags are associated with ‘ai-cancellation-request’ The ATLAS ticket sends an email to cancellations@triology.com and closes the ticket with a PR saying that the ticket has been sent to the correct team, to follow up email them. Once customer ticket 104 has passed the SRT check, the ATLAS ticket will route the customer tickets first to check ‘Does L2 offer a solution’ 318. If the L2 module does not provide a solution the customer ticket 104 is passed to the Does VF offer a solution? 316. The L1 module 126 looks for answers using the VF by accessing the knowledge base. If either of the bots is not able to provide a solution the ATLAS ticket routes customer ticket 104 to the tempo which in this case is a human agent 106 to resolve the issue.

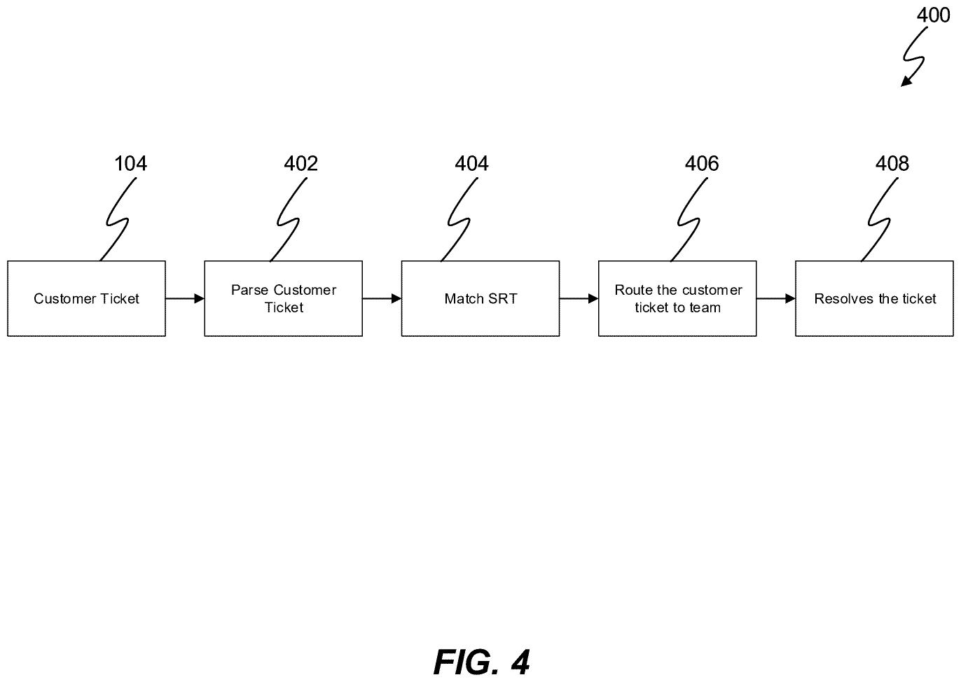

FIG. 4 depicts a customer ticket resolving process 400 showing the steps to resolve the customer ticket 104 using the customer support ticketing system 100 which is an embodiment of the customer support ticketing process 200 of FIG. 2.

The customer ticket 104 resolving process depicts the steps involved in resolving the customer ticker 104. Initially, the customer raises a customer ticket 104 on the ticket generation platform 102 for an issue he/she is facing while using a product or service. The ticket routing system 110 receives the customer ticket 102. The ticket parsing module 112 within the ticket routing system 110 utilizes the parsing techniques to parse customer ticket 402. The SRT matching module 114 utilizes the parsed customer ticket 402 to match the SRT 404. The match of the SRT involves matching customer ticket 104 to the predefined customer tickets within the SRT database 108.

The routing module 116 basis the matching, routes the customer tickets to team 406. The team can either be agent 106, L1 module 128, L2 module 126, or automation techniques. The ticket routing system provides the solution to the customer and resolves ticket 408.

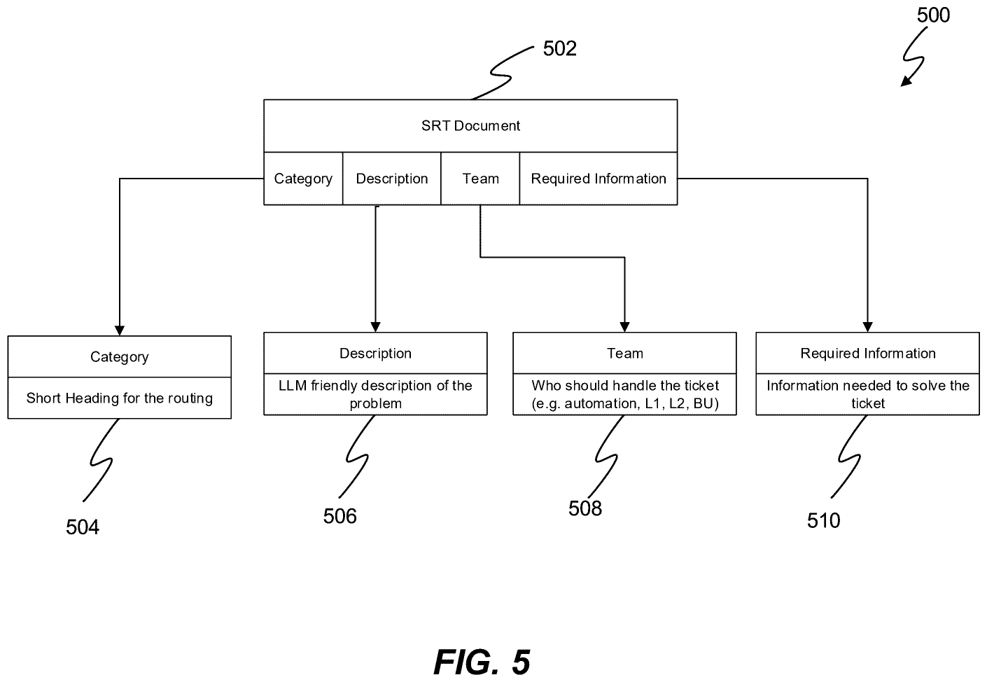

FIG. 5 depicts a data structure 500 for the structured routing document (SRT) to route the ticket to the relevant department or agent.

The data structure 500 for SRT document 502 comprises a plurality of nodes including Category 504, Description 506, Team 508, and required information 510. The category 504 is a short heading for the routing of customer ticket 104. The category 504 defines the problem related to the customer ticket For instance, if a customer raises a ticket on payment, the ticket will be categorized into invoice payment. For each category 504, a description 506 is provided. The description 506 node includes an LLM-friendly description of the problem. This structured approach helps in training machine learning models more effectively as it provides clear, concise, and relevant data points for AI to process and learn from.

The team 508 node specifies the team which will receive the ticket. The team 508 includes L1 support and L2 support businesses unit. This targeted routing is crucial for ensuring that tickets are handled by the most appropriate and capable team, reducing response times, and improving resolution efficiency. The required information 510 node includes information to solve the ticket. This ensures that the AI model can immediately assess whether all necessary data is present, which aids in faster and more accurate routing decisions.

For instance, a customer raised a customer ticket 104 for product ‘central finance’. The SRT document 502 for central finance has various categories. Customer ticket 104 includes a question on how to create an account in Expensify. The customer ticket 104 belongs to the category ‘Creating an account in Expensify’, with the description ‘If the requestor is asking to set an account for expenses or Expensify’ that includes the information on providing more detailed information on the inquiry of the customer. The required information includes ‘If there is no attachment or link to a document in the request respond asking them to create a copy of the following sheet and reply with it filled in https://docs.google.com/spreadsheets/d/1Q3S2gJv2EdKXpdw7r6kalP3noTgZ12As/edit#gid=206 8783697” it is very important to use this exact link.’ which defines the information that is required for the resolution of the issue. The team allocation includes the routing of the customer ticket to ‘L1 module’ 126.

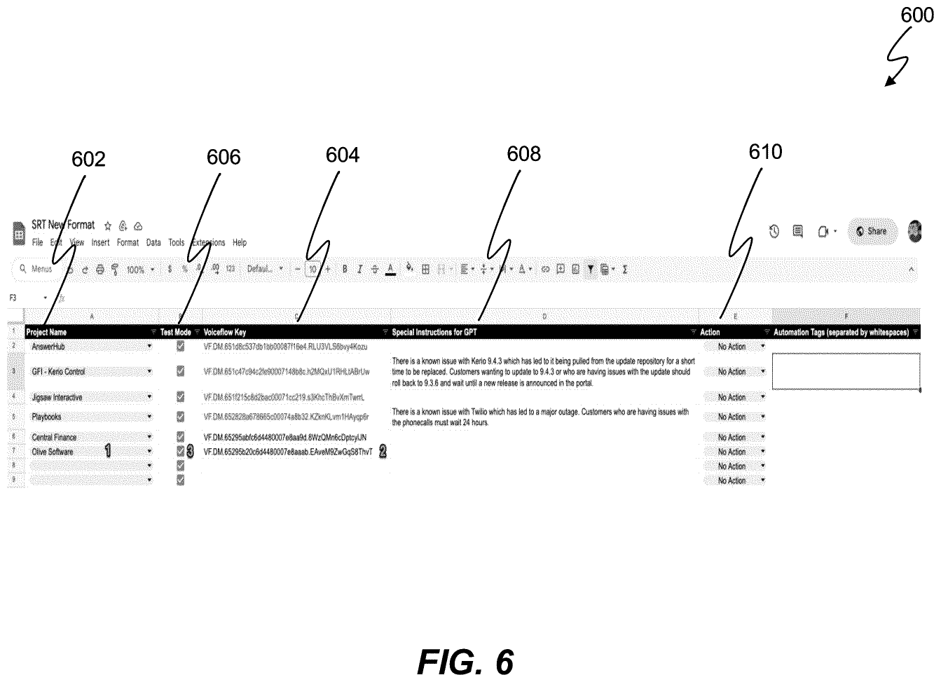

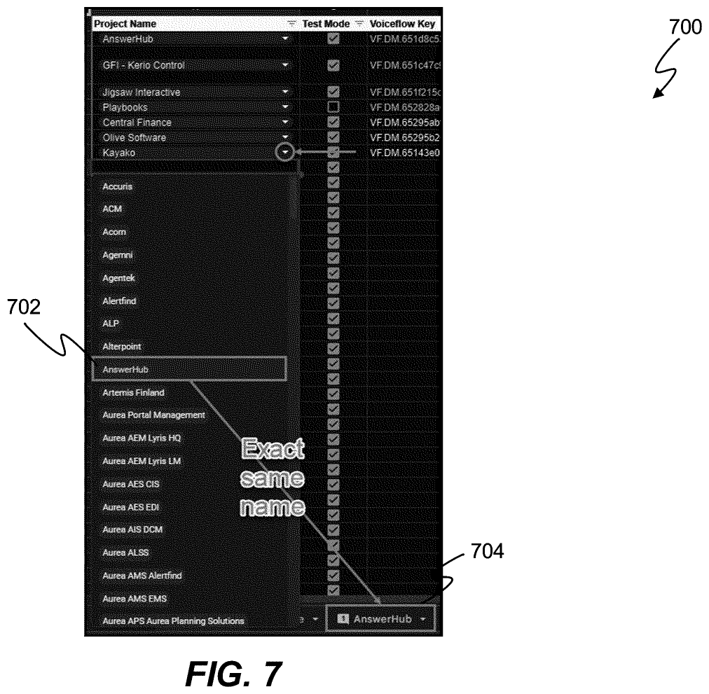

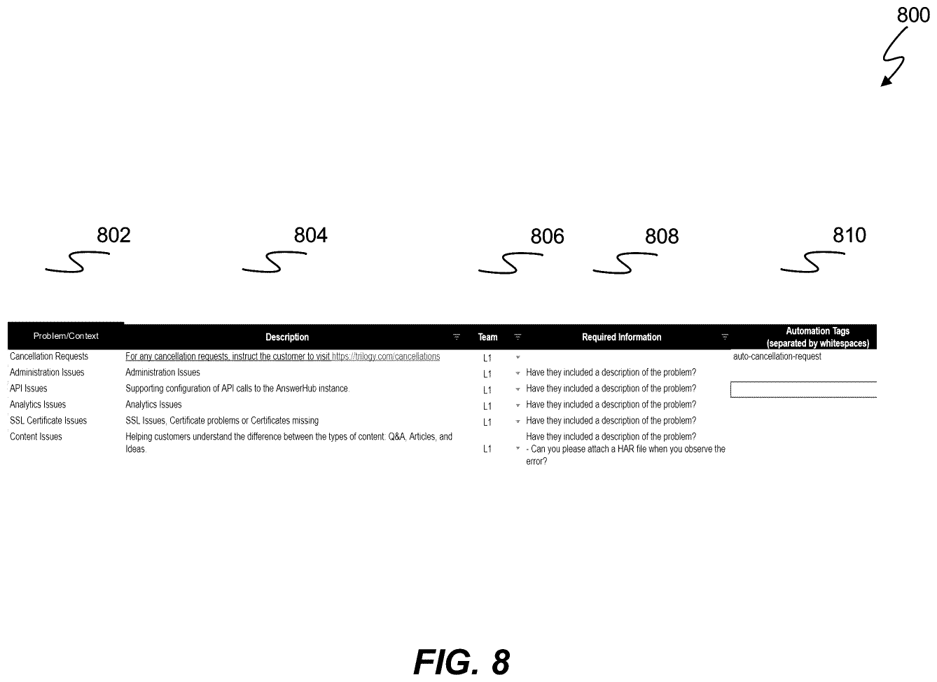

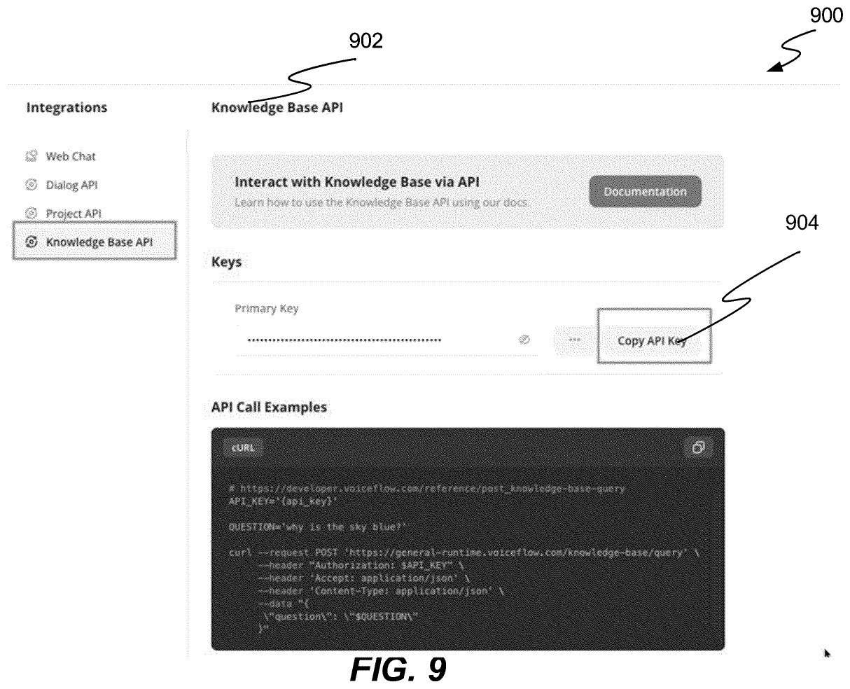

FIG. 6-9 depicts exemplary user interfaces 600, 700, 800, and 900 to implement the product in the ATLAS ticket utilizing the SRT database 108 to route the ticket to a relevant department.

The user interface 600 depicts the addition of the product in the SRT database 108. The user can add the product under project name 602. The project name 602 includes the addition of a product for which further details are provided. The user adds a Voice flow (VF) key 604 to access the knowledge base. The knowledge base includes a detailed solution for non-technical problems for that product. The product is first run in test mode 606 to ensure that the product details are validated before providing solutions to customer ticket 104. In testing mode, the ATLAS switches the SRT table to IN only to verify if the SRT guidance is working properly. The SRT guidance refers to the use of the SRT database 108 by the routing module 116 to route the customer ticket 104 to a relevant department.

The user also includes special instructions for GPT 608 which includes the urgent instructions and out-of-norm such as outage-related events for that particular product or service. The special instructions or tag allows the customer routing system 110 to put a tag on the customer ticket 104 within the ticket generation platform 102. Based on the special instructions and outage-related events for the product action 610 is provided where the ATLAS ticket sends a message to the customer for the special instructions and outage-related events.

The User Interface 700 includes the addition of the project name to a new tab and populate the product information.

The user copies the template tab 702 and renames the same tab in a new project tab named 704. The user populates the tab with the SRT guidance. The user should copy the same product which in this case is ‘AnswerHub’ to the new tab and populate the product with the SRT guidance. The SRT data for this product includes predefined data for the customer tickets that have been raised in the past. The SRT data updates as new customer tickets are raised on the customer generation platform 102.

The user interface 800 represents an exemplary SRT guidance to populate the fields for the product.

If the customer ticket 104 does not include special instructions or outage-related events, the ticket routing system 110 looks for the details of the product. The SRT guidance provides information related to customer ticket 104 to route the ticket to the relevant department. The SRT guidance includes a problem/content 802 information where the problem provides a heading for the issue. The issues here include headings such as cancellation, API issues, etc. The table also includes information on description 804 which provides context and added guidance on how a problem might be phrased within that column. The SRT guidance includes team 806 to choose where the issues will go. The SRT guidance herein includes that customer ticket 104 will be routed to L1 module 126.

The required information 808 includes the details necessary in customer ticket 104 to resolve the issue. Based on the customer issues raised the required information 808 tab is populated and the SRT table updates. The bot will respond to the customer if something is missing within the customer ticket 104 which is required to resolve the issue. The automation tags 810 are applied, including updating ticket information in the ticket generation platform 102. These tags can be useful in identifying what customer ticket 104 is at what stage.

The user interface 900 represents an exemplary where the L1 module accesses the knowledge base API to provide answers.

Once the customer ticket 104 passes the SRT check. The SRT table signifies the use of the L1 module 126 to find the answers to the issue raised in customer ticket 104. The knowledge base API 902 can be used to collect information relevant to non-technical issues raised in customer ticket 104. The user can copy API key 904 and enter in the Voice flow (VF) key 604 column via API. The user can click on the voice-flow key to access the knowledge base.

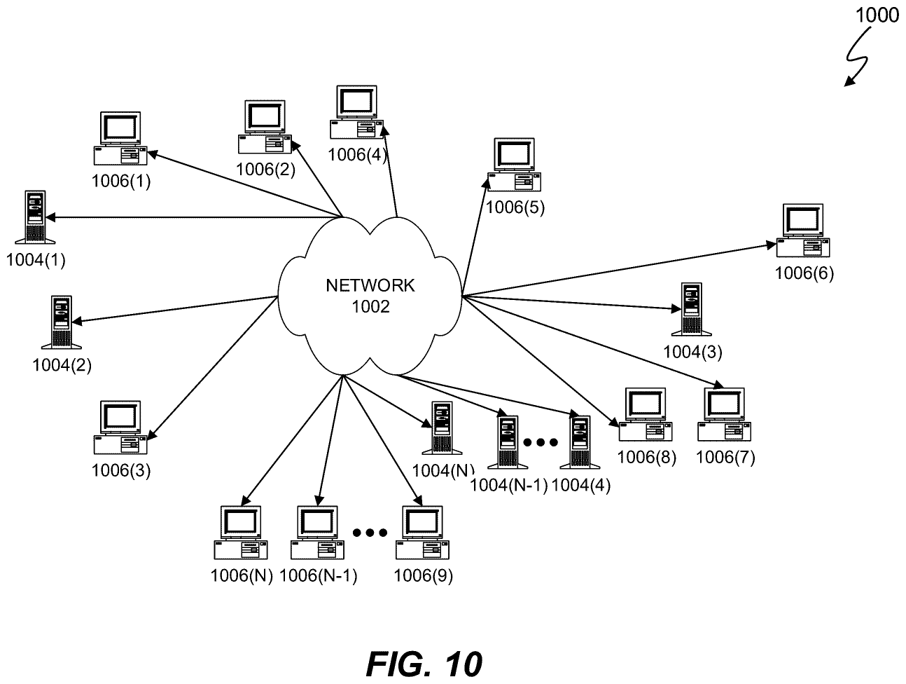

FIG. 10 is a block diagram illustrating a network environment in which a customer support ticketing system 1000 and customer support ticketing process 200 may be practiced. Network 1002 (e.g. a private wide area network (WAN) or the Internet) includes a number of networked server computer systems 1004(1)-(N) that are accessible by client computer systems 1006(1)-(N), where N is the number of server computer systems connected to the network. Communication between client computer systems 1006(1)-(N) and server computer systems 1004(1)-(N) typically occurs over a network, such as a public switched telephone network over asynchronous digital subscriber line (ADSL) telephone lines or high-bandwidth trunks, for example communications channels providing T1 or OC3 service. Client computer systems 1006(1)-(N) typically access server computer systems 1004(1)-(N) through a service provider, such as an internet service provider (“ISP”) by executing application specific software, commonly referred to as a browser, on one of client computer systems 1006(1)-(N).

Client computer systems 1006(1)-(N) and/or server computer systems 1004(1)-(N) are specialized computer programmed to improve conventional computer systems to implement and utilize the customer support ticketing system 100 and customer support ticketing process 200. The type of computer system that can be specially programmed to implement and utilize the customer support ticketing system 100 and customer support ticketing process 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the customer support ticketing system 100 and customer support ticketing process 200 can be implemented using code stored in a tangible, non-transient computer readable medium and executed by one or more processors. In at least one embodiment, the customer support ticketing system 100 and customer support ticketing process 200 can be implemented completely in hardware using, for example, logic circuits and other circuits including field programmable gate arrays.

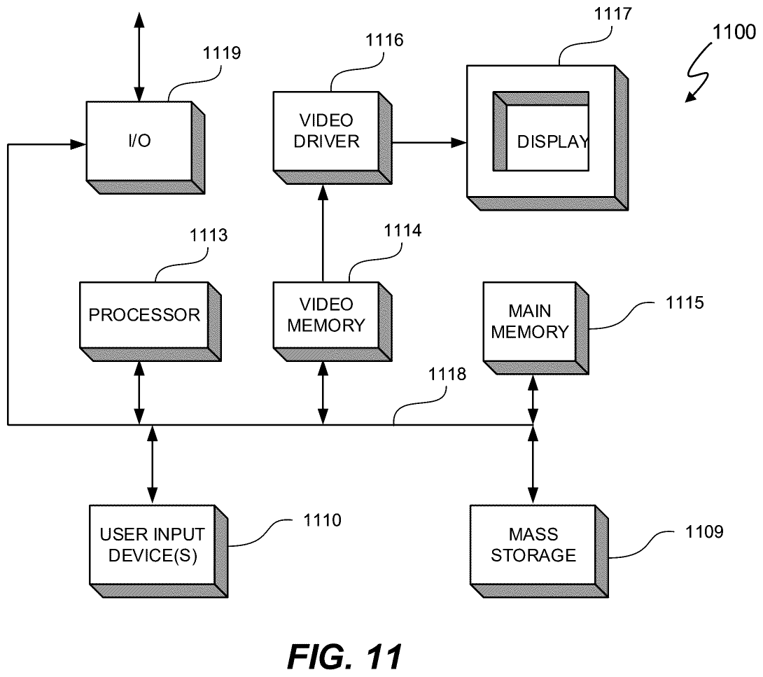

Embodiments of the customer support ticketing system 100 and customer support ticketing process 200 can be implemented on a computer system such as a special-purpose, special-programmed computer 1100 illustrated in FIG. 11. Input user device(s) 1110, such as a keyboard and/or mouse, are coupled to a bi-directional system bus 1118. The input user device(s) 1110 are for introducing user input to the computer system and communicating that user input to processor 1113. The computer system of FIG. 11 generally also includes a non-transitory video memory 1114, non-transitory main memory 1115, and non-transitory mass storage 1109, all coupled to bi-directional system bus 1118 along with input user device(s) 1110 and processor 613. The mass storage 609 may include both fixed and removable media, such as a hard drive, one or more CDs or DVDs, solid state memory including flash memory, and other available mass storage technology. Bus 1118 may contain, for example, 32 of 64 address lines for addressing video memory 1114 or main memory 1115. The system bus 618 also includes, for example, an n-bit data bus for transferring DATA between and among the components, such as CPU Y09, main memory 1115, video memory 614 and mass storage 1109, where “n” is, for example, 32 or 64. Alternatively, multiplex data/address lines may be used instead of separate data and address lines.

I/O device(s) 1119 may provide connections to peripheral devices, such as a printer, and may also provide a direct connection to a remote server computer systems via a telephone link or to the Internet via an ISP. I/O device(s) 1119 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 1109, into main memory 1115 for execution. “Memory” can be a single memory component or a collection of multiple memory components. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 1113, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 1115 is comprised of dynamic random access memory (DRAM). Video memory 1114 is a dual-ported video random access memory. One port of the video memory 1114 is coupled to video amplifier 1116. The video amplifier 1116 is used to drive the display 617. Video amplifier 1116 is well known in the art and may be implemented by any suitable means. This circuitry converts pixel DATA stored in video memory 1114 to a raster signal suitable for use by display 1117. Display 1117 is a type of monitor suitable for displaying graphic images.

The computer system described above is for purposes of example only. The customer support ticketing system 100 and customer support ticketing process 200 may be implemented in any type of computer system or programming or processing environment. It is contemplated that the customer support ticketing system 100 and customer support ticketing process 200 might be run on a stand-alone computer system, such as the one described above. The customer support ticketing system 100 and customer support ticketing process 200 might also be run from a server computer systems system that can be accessed by a plurality of client computer systems interconnected over an intranet network. Finally, the customer support ticketing system 100 and customer support ticketing process 200 may be run from a server computer system that is accessible to clients over the Internet.

Although embodiments have been described in detail, it should be understood that various changes, substitutions, and alterations can be made hereto without departing from the spirit and scope of the invention as defined by the appended claim.

What is claimed is:

1. A method for guiding an Artificial Intelligence (AI) engine to route a customer ticket to a relevant department or agent comprising:
executing codes using one or more processors of a computer system to cause the computer system to perform operations comprising:
receiving, via a ticket generation platform, a customer ticket including one or more issues related to a product or service;
accessing a structured routing document (SRT) database, including details related to one or more customer tickets, to look up if the received ticket includes one or more predefined information related to the ticket;
generating a prompt, via a prompt generator, for routing the ticket to the relevant department or agent for issue resolution using an automation workflow;
providing the generated prompt to the AI engine, wherein the AI engine analyzes the prompt and the predefined information to pass on the ticket to the relevant department or agent for resolution;
if the AI engine determines that the information is insufficient, then the AI engine instructs the ticket routing system to close the ticket, wherein closing the ticket will exit the ticket from automation workflow and assign the ticket to an agent; and
if the AI engine determines that the information is adequate, then the AI engine instructs a ticket routing system to proceed and generate prompts for the next steps in the automaton workflow;
passing the ticket to one or more automation levels for resolution, wherein the ticket is passed to the level 1 automation if the ticket is related to a non-technical topic that can be solved by looking up in a knowledge base or passed to level 2 automation if the ticket is related to a technical topic;
closing the ticket if the ticket is not qualified to be passed to level 1 or level 2 automation, wherein the ticket is passed to a human agent for resolution.

2. The method of claim 1 further comprises:
parsing the received ticket to extract relevant information from the customer ticket;
matching the extracted information against the SRT database to find a relevant routing path as per the automation workflow;
routing the ticket to the designated department or agent based on the SRT matching.

3. The method of claim 1 wherein the ticket generation platform is one or more customer support platforms including Zendesk or Kayako.

4. The method of claim 1 wherein the customer ticket includes inquiries about issues faced by the customer. while using one or more products or services linked to the ticket generation platform.

5. The method of claim 1 wherein the ticket routing system is ATLAS, wherein ATLAS is configured to initiate the automation workflow upon receipt of a new customer ticket.

6. The method of claim 1 wherein the ticket routing system sends an API request to check if the received customer ticket includes enough information to initiate the automation workflow, wherein the API request allows the ticket routing system to receive customer ticket details from the structured routing document database (SRT).

7. The method of claim 1 wherein the ticket routing system sends an API request to a status page of the product or service to confirm if there is an outage event related to the product or service.

8. The method of claim 7 wherein the ticket routing system parses the ticket content and deflects the ticket if the customer ticket is related to an outage related to the product or service.

9. The method of claim 1 wherein the method further comprises:
applying one or more tags to the customer ticket based on the stage of the automation workflow comprising:
applying a more info tag ‘atlas-ticket-more info’ if the customer ticket does not include enough information to initiate the automation workflow;
applying an automation tag ‘atlas-ticket-complete’ where the received customer ticket is automatically resolved by the automation module ticket routing system;
applying a Level 1 tag ‘atlas-ticket-l1attempt’ where the received customer ticket is passed to the Level 1 module automation module for resolution; and
applying a Level 2 tag ‘atlas-ticket-l2attempt complete’ where the received customer ticket is passed to the Level 2 module automation for resolution.

10. The method of claim 1 wherein the method further utilizes one or more machine learning models configured to use the details included in the structured routing document (SRT) for efficient and accurate ticket routing.

11. A system for guiding an Artificial Intelligence (AI) engine to route a customer ticket to a relevant department or agent comprising:
one or more processors of a computer system; and
a memory, coupled to the one or more processors, that stores code and execution of the code by the one or more processors causes the computer system to perform operations comprising:
executing codes using one or more processors of a computer system to cause the computer system to perform operations comprising:
receiving, via a ticket generation platform, a customer ticket including one or more issues related to a product or service;
accessing a structured routing document (SRT) database, including details related to one or more customer tickets, to look up if the received ticket includes one or more predefined information related to the ticket;
generating a prompt, via a prompt generator, for routing the ticket to the relevant department or agent for issue resolution using an automation workflow;
providing the generated prompt to the AI engine, wherein the AI engine analyzes the prompt and the predefined information to pass on the ticket to the relevant department or agent for resolution;
if the AI engine determines that the information is insufficient, then the AI engine instructs the ticket routing system to close the ticket, wherein closing the ticket will exit the ticket from automation workflow and assign the ticket to an agent; and
if the AI engine determines that the information is adequate, then the AI engine instructs a ticket routing system to proceed and generate prompts for the next steps in the automaton workflow;
passing the ticket to one or more automation levels for resolution, wherein the ticket is passed to the level 1 automation if the ticket is related to a non-technical topic that can be solved by looking up in a knowledge base or passed to level 2 automation if the ticket is related to a technical topic;
closing the ticket if the ticket is not qualified to be passed to level 1 or level 2 automation, wherein the ticket is passed to a human agent for resolution.

12. The system of claim 11 further comprises:
parsing the received ticket to extract relevant information from the customer ticket;
matching the extracted information against the SRT database to find a relevant routing path as per the automation workflow;
routing the ticket to the designated department or agent based on the SRT matching.

13. The system of claim 11 wherein the ticket generation platform is one or more customer support platforms including Zendesk or Kayako.

14. The system of claim 11 wherein the customer ticket includes inquiries about issues faced while using one or more products or services linked to the ticket generating platform.

15. The system of claim 11 wherein the ticket routing system is ATLAS, wherein ATLAS is configured to initiate the automation workflow upon receipt of a new customer ticket.

16. The system of claim 11 wherein the ticket routing system sends an API request to check if the received customer ticket includes enough information to initiate the automation workflow, wherein the API request allows the ticket routing system to receive customer ticket details from the structured routing document (SRT).

17. The system of claim 11 wherein the ticket routing system sends an API request to a status page of the product or service to confirm if there is an outage event related to the product or service.

18. The system of claim 11 wherein the ticket routing system parses the ticket content and deflects the ticket if the customer ticket is related to an outage related to the product or service.

19. The system of claim 11 wherein the system further comprises:
applying one or more tags to the ticket customer ticket based on the stage of the automation workflow including:
applying a more info tag ‘atlas-ticket-moreinfo’ if the customer ticket does not include enough information to initiate the automation workflow;
applying an automation tag ‘atlas-ticket-complete’ where the received customer ticket is automatically resolved by the ticket routing system;
applying a Level 1 tag ‘atlas-ticket-l1attempt’ where the received customer ticket is passed to the Level 1 automation for resolution; and
applying a Level 2 tag ‘atlas-ticket-l2attempt complete’ where the received customer ticket is passed to the Level 2 automation for resolution.

20. The system of claim 1 wherein the system further utilizes one or more machine learning models configured to use the details included in the structured routing document (SRT) for efficient and accurate ticket routing.
